(19) United States
(12) Patent Application Publication
(10) Pub. No.: US 2025/0369274 A1
(43) Pub. Date: Dec. 4, 2025

(54) AUTOMATIC DOOR OPENING ASSEMBLY FOR A WASHING MACHINE APPLIANCE

(71) Applicant: Haier US Appliance Solutions, Inc., Wilmington, DE (US)

(72) Inventors: Benjamin Beyerle, Louisville, KY (US); Benjamin David Thomas, Toledo, OH (US); Aidan Fox, North Olmstead, OH (US); Matthew Grau, North Ridgeville, OH (US); Kieya McClung, Fishers, IN (US)

(21) Appl. No.: 18/677,316

(22) Filed: May 29, 2024

(51) Int. Cl. E05F 15/73; D06F 23/02; D06F 34/14; D06F 39/14; D06F 101/00; D06F 103/00; D06F 103/32; D06F 105/44; D06F 105/46; E05F 15/616

(52) U.S. Cl. CPC E05F 15/73; D06F 23/02; D06F 34/14; D06F 39/14; E05F 15/616; D06F 2101/00; D06F 2103/00; D06F 2103/32; D06F 2105/44; D06F 2105/46; E05F 2015/763; E05Y 2201/484; E05Y 2900/312

(57) ABSTRACT

A washing machine appliance includes a cabinet including a front panel defining a chamber opening, a wash tub positioned within the cabinet and defining a wash chamber, a door rotatably mounted to the front panel and moveable between open and closed positions, and an automatic door opening assembly for rotating the door from the closed to the open position. The door opening assembly includes a linear actuator including a rod moveable between a retracted and extended position in which the rod moves the door from the closed position, a sensor for detecting a contactless user input to move the door from the closed to the open position, and a controller operatively coupled to the sensor and the actuator. The controller is configured to control the operation of the actuator to move the rod from the retracted to the extended position upon detection of the input.

### FIELD OF THE INVENTION

The present subject matter relates generally to washing machine appliances, or more specifically, to the automatic door opening assembly of a washing machine appliance.

### BACKGROUND OF THE INVENTION

Washing machine appliances generally include a tub for containing water or wash fluid, e.g., water and detergent, bleach, and/or other wash additives. A basket is rotatably mounted within the tub and defines a wash chamber for receipt of articles for washing. Washing machine appliances also generally include a door that can be opened to provide access to the wash chamber and closed to prohibit access to the wash chamber. During normal operation of such washing machine appliances, the wash fluid is directed into the tub and onto articles within the wash chamber of the basket. The basket or an agitation element can rotate at various speeds to agitate articles within the wash chamber, to wring wash fluid from articles within the wash chamber, etc. During a spin or drain cycle, a drain pump assembly may operate to discharge water from within sump.

Certain conventional washing machine appliances include a door with a door handle that requires a user to manually open and close the doors to access the wash chamber. Manually opening the door of a washing machine appliance requires the user's hands to be free to do so. However, oftentimes a user's hands may be holding a laundry basket or otherwise be occupied. Various assemblies and systems have been developed to resolve these issues. However, further improvements are needed.

Accordingly, a washing machine appliance having an improved automatic door opening assembly would be desirable. More specifically, an automatic door opening assembly that allows the door of the washing machine appliance to be opened with a contactless user input would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a washing machine appliance is provided including a cabinet including a front panel defining a chamber opening, a wash tub positioned within the cabinet and defining a wash chamber, a door rotatably mounted to the front panel and moveable between an open position for providing access to the wash chamber and a closed position for prohibiting access to the wash chamber, and an automatic door opening assembly for selectively rotating the door from the closed position to the open position. The automatic door opening assembly includes a linear actuator including a rod moveable between a retracted position and an extended position in which the rod moves the door from the closed position, a sensor for detecting a contactless user input to move the door from the closed position to the open position, and a controller operatively coupled to the sensor and the linear actuator. The controller is configured to control an operation of the linear actuator to move the rod from the retracted position to the extended position upon detection of the contactless user input by the sensor.

In another exemplary embodiment, an automatic door opening assembly for a washing machine appliance is provided. The washing machine appliance includes a cabinet including a front panel defining a chamber opening, a wash tub positioned within the cabinet and defining a wash chamber, and a door rotatably mounted to the front panel and moveable between an open position for providing access to the wash chamber and a closed position for prohibiting access to the wash chamber. The automatic door opening assembly includes a linear actuator including a rod moveable between a retracted position and an extended position in which the rod moves the door from the closed position, a sensor for detecting a contactless user input to move the door from the closed position to the open position, and a controller operatively coupled to the sensor and the linear actuator. The controller is configured to control an operation of the linear actuator to move the rod from the retracted position to the extended position upon detection of the contactless user input by the sensor.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a washing machine appliance according to an example embodiment of the present subject matter.

FIG. 2 provides a front view of the example washing machine appliance of FIG. 1 with a door in the open position according to an example embodiment of the present subject matter.

FIG. 3 provides a side cross-sectional view of the example washing machine appliance of FIG. 1 according to an example embodiment of the present subject matter.

FIG. 4 provides another side cross-sectional view of the example washing machine appliance of FIG. 1 according to an example embodiment of the present subject matter.

FIG. 5 provides another perspective view of the example washing machine appliance of FIG. 1 according to an example embodiment of the present subject matter.

FIG. 6 provides another perspective view of the example washing machine appliance of FIG. 1 according to an example embodiment of the present subject matter.

FIG. 7 provides a flow diagram of one embodiment of a method for automatically opening the door of a washing machine appliance according to an embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

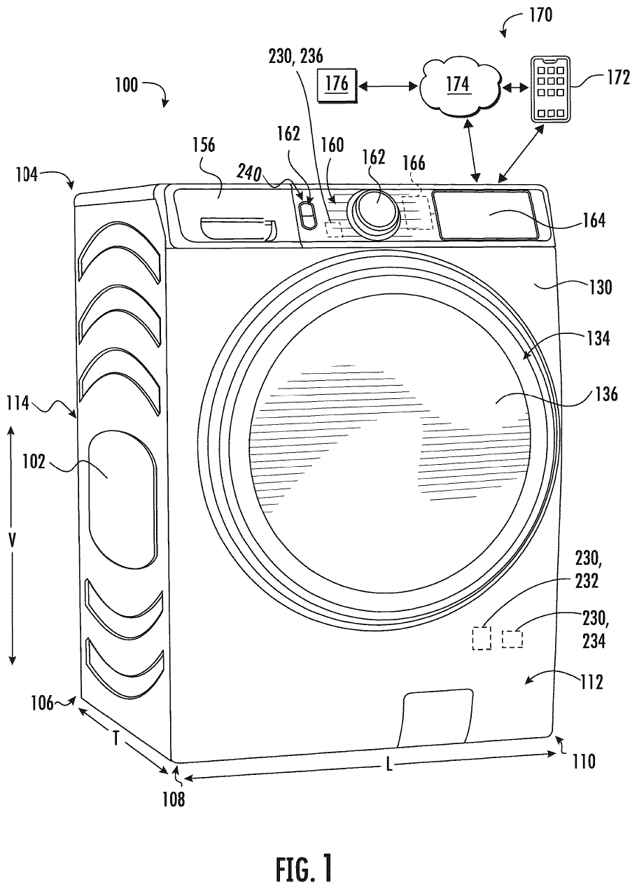

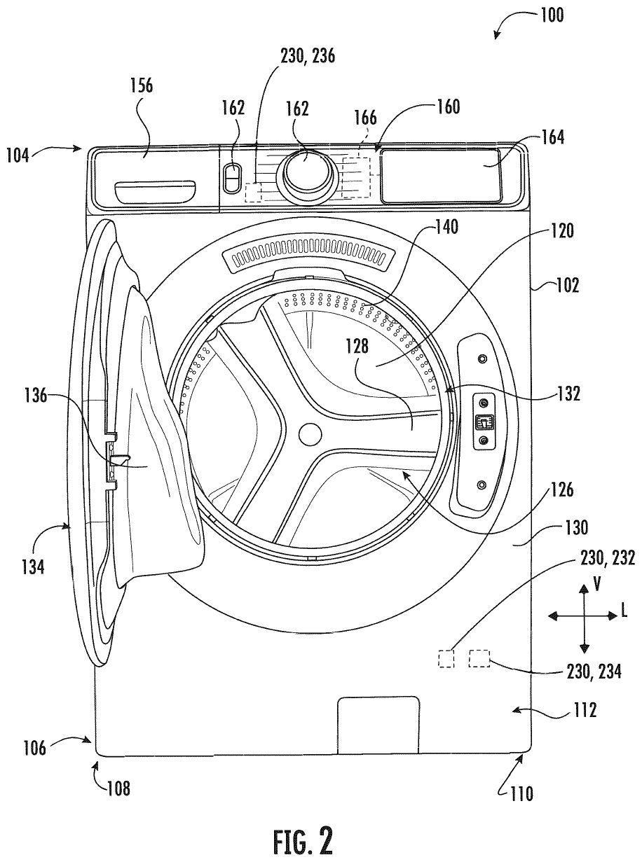

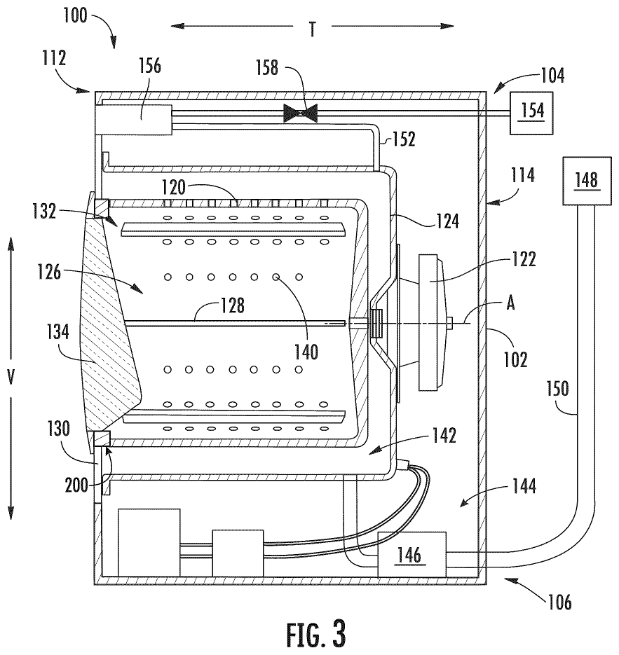

Referring now to the figures, FIG. 1 is a perspective view of an exemplary horizontal axis washing machine appliance 100, FIG. 2 is a front view of washing machine appliance 100, FIG. 3 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined. Washing machine appliance 100 includes a cabinet 102 that extends between a top 104 and a bottom 106 along the vertical direction V, between a left side 108 and a right side 110 along the lateral direction, and between a front 112 and a rear 114 along the transverse direction T.

Referring to FIGS. 2 and 3, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 3, a plurality of ribs 128 extends from basket 120 into wash chamber 126. In this manner, for example, ribs 128 may lift articles disposed in wash basket 120 during rotation of wash basket 120.

Referring generally to FIGS. 1 through 3, cabinet 102 also includes a front panel 130 which defines a chamber opening 132 that permits user access to wash basket 120 of wash tub 124. More specifically, washing machine appliance 100 includes a door 134 that is positioned over chamber opening 132 and is rotatably mounted to front panel 130. In this manner, door 134 permits selective access to chamber opening 132 by being movable between an open position (FIG. 2) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. The door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments.

As best illustrated in FIG. 3, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

A spout 152 is configured for directing a flow of fluid into wash tub 124. For example, spout 152 may be in fluid communication with a water supply 154 in order to direct fluid (e.g., clean water or wash fluid) into wash tub 124. Spout 152 may also be in fluid communication with the sump 142. For example, pump assembly 144 may direct wash fluid disposed in sump 142 to spout 152 in order to circulate wash fluid in wash tub 124.

A detergent drawer 156 is slidably mounted within front panel 130. Detergent drawer 156 receives a wash additive (e.g., detergent, fabric softener, bleach, or any other suitable liquid or powder) and directs the fluid additive to wash tub 124 during operation of washing machine appliance 100. According to the illustrated embodiment, detergent drawer 156 may also be fluidly coupled to spout 152 to facilitate the complete and accurate dispensing of wash additive.

In addition, a water supply valve 158 may provide a flow of water from a water supply source (such as a municipal water supply 154) into detergent drawer 156 and into wash tub 124. In this manner, water supply valve 158 may generally be operable to supply water into detergent drawer 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

As best illustrated in FIGS. 1 and 2, a control panel 160 including a plurality of input selectors 162 is coupled to front panel 130. Control panel 160 and input selectors 162 collectively form a user interface input for operator selection of machine cycles and features. For example, in one embodiment, a display 164 indicates selected features, a countdown timer, and/or other items of interest to machine users.

Operation of washing machine appliance 100 is controlled by a controller or processing device 166 (FIG. 1) that is operatively coupled to control panel 160 for user manipulation to select washing machine cycles and features. In response to user manipulation of control panel 160, controller 166 operates the various components of washing machine appliance 100 to execute selected machine cycles and features.

Controller 166 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 166 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Control panel 160 and other components of washing machine appliance 100 may be in communication with controller 166 via one or more signal lines or shared communication busses.

During operation of washing machine appliance 100, laundry items are loaded into wash basket 120 through chamber opening 132, and washing operation is initiated through operator manipulation of input selectors 162. Wash tub 124 is filled with water, detergent, and/or other fluid additives, e.g., via spout 152 and or detergent drawer 156. One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain pump assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through chamber opening 132.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances.

Referring to FIG. 1, a schematic diagram of an external communication system 170 will be described according to an exemplary embodiment of the present subject matter. In general, external communication system 170 is configured for permitting interaction, data transfer, and other communications between washing machine appliance 100 and one or more external devices. For example, this communication may be used to provide and receive operating parameters, user instructions or notifications, performance characteristics, user preferences, or any other suitable information for improved performance of washing machine appliance 100. In addition, it should be appreciated that external communication system 170 may be used to transfer data or other information to improve performance of one or more external devices or appliances and/or improve user interaction with such devices.

For example, external communication system 170 permits controller 166 of washing machine appliance 100 to communicate with a separate device external to washing machine appliance 100, referred to generally herein as an external device 172. As described in more detail below, these communications may be facilitated using a wired or wireless connection, such as via a network 174. In general, external device 172 may be any suitable device separate from washing machine appliance 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with washing machine appliance 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control washing machine appliance 100, etc. In addition, external device 172 and remote server 176 may communicate with washing machine appliance 100 to communicate similar information.

In general, communication between washing machine appliance 100, external device 172, remote server 176, and/or other user devices or appliances may be carried using any type of wired or wireless connection and using any suitable type of communication network, non-limiting examples of which are provided below. For example, external device 172 may be in direct or indirect communication with washing machine appliance 100 through any suitable wired or wireless communication connections or interfaces, such as network 174. For example, network 174 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Referring now to FIGS. 1 and 4 through 7, an automatic door opening assembly 200 that may be used with the washing machine appliance 100 and an associated method for automatically opening the door of a washing machine appliance will be described according to example embodiments of the present subject matter. The automatic door opening assembly 200 is used to automatically and selectively open the door 134 of the washing machine appliance 100 upon contactless prompting by the user such that the door rotates from the closed position (FIG. 1) to the open position (FIG. 2). As such, as will be described below, the automatic door opening assembly 200 includes a linear actuator 210 for moving the door 134 from the closed position, a sensor 230 for detecting a contactless user input, and the controller 166 of the washing machine appliance 100 for controlling the linear actuator 210 to move the door 134 from the closed position upon detection of the contactless user input by the sensor 220.

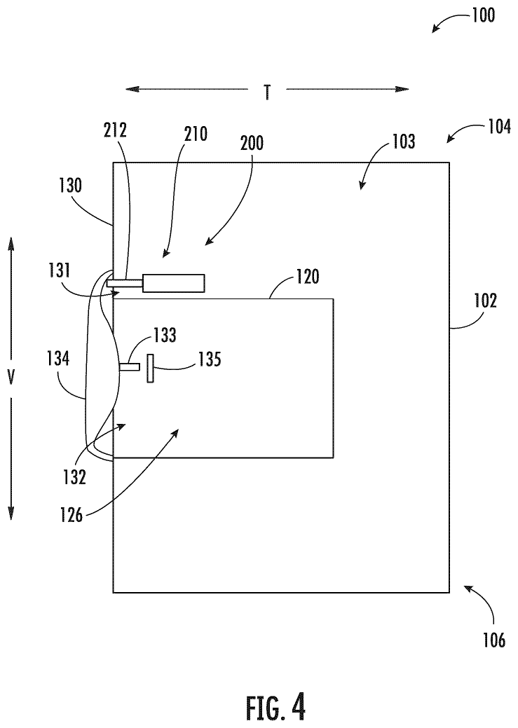

According to example embodiments, the automatic door opening assembly 200 includes the linear actuator 210 for moving the door 134 of the washing machine appliance 100 from the closed position. As best illustrated in FIG. 4, the linear actuator 210 may include a rod 212 moveable between a retracted position (not shown) in which the rod 212 does not contact the door 134 and an extended position (FIG. 4) in which the rod 212 contacts the door 134 to move the door 134 from the closed position. The linear actuator 210 may thus correspond to a solenoid that utilizes, for example, an electromagnetic force to extend and retract the rod 212. Furthermore, the linear actuator 210 may be operatively coupled to the controller 166. In this respect, the controller 166 may control the operation of the linear actuator 210 so that the rod 212 may be extended and retracted when prompted by the controller 166.

Notably, the linear actuator 210 may be positioned within an interior 103 of the cabinet 102 of the washing machine appliance 100 behind the front panel 130. The front panel 130 may define an opening 131 therethrough and positioned between and aligned with the door 134 and the rod 212 of the linear actuator 210 such that the rod 212 may extend and through the opening 131 to contact the door 134 and, thus, move the door 134 from the closed position. As shown in FIG. 4, the door 134 may include a latch insert 133 to be received within a latch receiver or slot 135 of the front panel 130 when the door 134 is in the closed position. The latch insert 133 may include features such as raised edges (not shown) that hold the door 134 in the closed position when the latch insert 133 is received within the latch slot 135. When the rod 212 of the linear 210 moves to the extended position, the rod 212 contacts the door 134 and applies pressure to the door 134 such that the latch insert 133 is detached from the latch slot 135 and, thus, the door 134 is moved from the closed position.

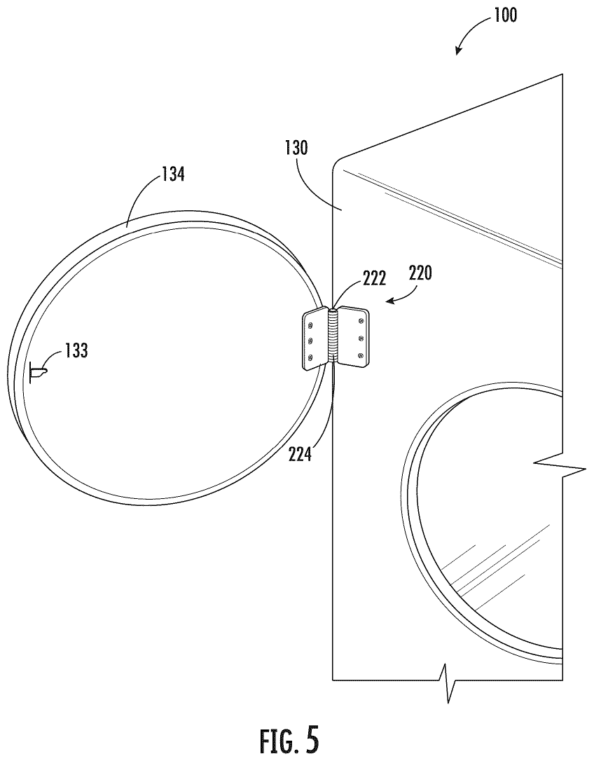

According to example embodiments, the automatic door opening assembly 200 includes one or more door hinges 220 coupled to the door 134 and the front panel 130 of the washing machine appliance 100 for facilitating rotation of the door 134 between the open position and the closed position. The door hinge(s) 220 may include a hinge actuator for moving the door 134 to the open position after the linear actuator 210 moves the door 134 from the closed position. For example, as best illustrated in FIG. 5, the hinge actuator may be configured as a coil spring 222. The coil spring 222 may be wrapped around a shaft 224 of the door hinge(s) 220 and may apply a pressure between the door 134 and the front panel 130 that moves the door 134 toward the open position once the latch insert 133 has been detached from the latch slot 135 due to the rod 212 of the linear actuator 210 applying pressure to the door 134. As such, once the door 134 has been moved from the closed position, the pressure applied by the coil spring 222 may move the door 134 to the open position without any additional pressure applied to move the door 134 to the open position.

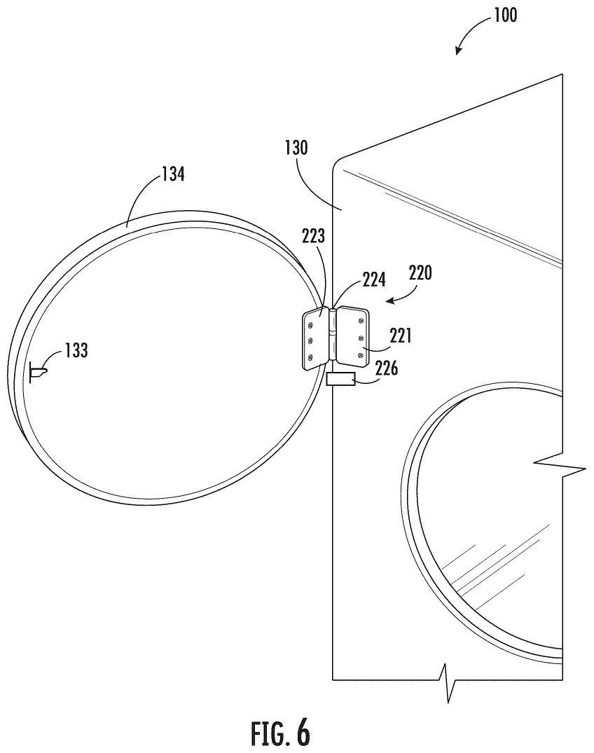

Additionally, or alternatively, in some embodiments, the hinge actuator may be configured as a motor 226, e.g., a DC motor, operable to move the door 134 to the open position. In some embodiments, the motor 226 may move the door 134 to the open position after the linear actuator 210 moves the door 134 from the closed position. For example, as best illustrated in FIG. 6, the motor 226 may be coupled to the shaft 224 of the door hinge(s) 220. The door hinge(s) 220 may also include a first hinge bracket 221 coupled to the front panel 130 of the washing machine appliance 100 and a second hinge bracket 223 coupled to the door 134. The first and second hinge brackets 221, 223 may be coupled to each other via the shaft 224, which extends through shaft openings of the hinge brackets 221, 223 for coupling the hinge brackets 221, 223 to each other. Additionally, the shaft 224 may be fixedly coupled to the second hinge bracket 223 such that the second hinge bracket 223 and the shaft 224 move together relative to the first hinge bracket 221. In this respect, the motor 226 may drive rotation of the shaft 224 which moves the second hinge bracket 223 relative to the first hinge bracket 221 and, thus, moves the door 134 to the open position once the door 134 has been moved from the closed position by the linear actuator 210. However, it should be appreciated that in alternative embodiments, the motor 226 may also move the door 134 to the open position without the linear actuator 210. For example, when the motor 226 drives rotation of the shaft 224, the torque applied by the motor 226 may be sufficient to move the door 134 from the closed position and to the open position. Furthermore, the motor 226 may be operatively coupled to the controller 166 such that the controller 166 may prompt control the operation of the motor 226 for driving rotation of the shaft 224.

According to example embodiments, the automatic door opening assembly 200 may include one or more sensors 230. The sensor(s) 230 may be operatively coupled to the controller 166 such that, as will be described below, the controller 166 may control the operation of the linear actuator 210 to move the rod 212 from the retracted position to the extended position to move the door 134 from the closed position upon detection of the contactless user input by the sensor(s) 230. As best illustrated in FIG. 1, the sensor(s) 230 may be positioned on the front panel 130 of the washing machine appliance 100 and configured to detect a contactless user input. For example, in some embodiments, the sensor(s) 230 may be configured as a motion or proximity sensor(s) 232 for detecting motion corresponding to the contactless user input. The proximity sensor(s) 232 may be positioned on the front panel 130 below the door 134 with a detection zone external of the washing machine appliance 100. As such, the proximity sensor(s) 232 may detect, for example, a user waving a foot or hand in front of the proximity sensor(s) 232, which may be an indication by the user to move the door 134 from the closed position to the open position.

Additionally, or alternatively, in some embodiments, the sensor(s) 230 may be configured as a thermal or temperature sensor(s) 234 for detecting a temperature differential corresponding to the contactless user input. The temperature sensor(s) 234 may be positioned on the front panel 130 below the door 134 with a detection zone external of the washing machine appliance 100. As such, the temperature sensor(s) 234 may detect, for example, a change in temperature differential due to the body temperature of a user being higher than the ambient or room temperature when a user waves their hand or foot in front of the temperature sensor(s) 234.

Additionally, or alternatively, in some embodiments, the sensor(s) 230 may be configured as a sound receiving device(s) or microphone(s) 236. The microphone(s) 236 may receive a voice command from the user to open the door 134. As will be described below, the controller 166 may use voice commands detected by the microphone(s) 236 to open the door 134. In some embodiments, the controller 166 may distinguish a specific user's voice and use voice commands detected by the microphone(s) 236 from the specific user to open the door 134.

According to example embodiments, the automatic door opening assembly 200 may include a switch 240 that a user may activate to control the operation of the linear actuator 210 to move the rod 212 from the retracted position to the extended position to move the door 134 from the closed position. The switch 240 may be any suitable kind of switch that the user may activate. For example, the switch 240 may be a toggle switch, pushbutton switch, selector switch, etc.

According to example embodiments, the automatic door opening assembly 200 includes the controller 166. The controller 166 may be operatively coupled to the linear actuator 210, the sensor(s) 230, and the switch 240. Additionally, in embodiments of the automatic door opening assembly 200 that include the motor 220, the controller 166 may be operatively coupled to the motor 166. As such, the controller 166 may be configured to control the operation of the linear actuator 210 and/or the motor 220 to move the door 134 from the closed position to the open position upon detection of the contactless user input by the sensor(s) 230.

Now that the construction of the exemplary washing machine appliance 100, the automatic door opening assembly 200, and the configuration of controller 166 according to exemplary embodiments have been presented, an exemplary method 300 of automatically opening the door of a washing machine appliance will be described. In this regard, method 300 provides an example method for automatically opening the door of a washing machine appliance upon detection of a contactless user input. Although the discussion below refers to the exemplary method 300 of automatically opening the door of washing machine appliance 100, one skilled in the art will appreciate that the exemplary method 300 is applicable to automatically opening the door of other household appliances, such as a dryer appliance. In exemplary embodiments, the various method steps as disclosed herein may be performed by controller 166.

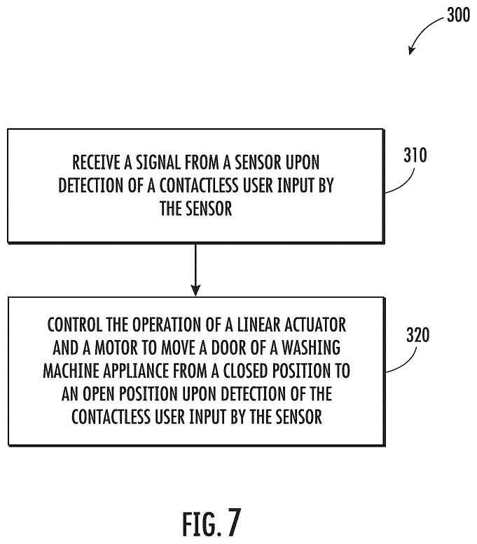

Referring now to FIG. 7, method 300 includes, at step 310, receiving a signal from the sensor(s) 230 upon detection by the sensor(s) 230 of the contactless user input. As mentioned previously, the controller 166 may be operatively coupled to the sensor(s) 230, such as to the proximity sensor(s) 232, the temperature sensor(s) 234, and/or the microphone(s) 236. As such, the controller 166 may receive a signal from the proximity sensor(s) 232, the temperature sensor(s) 234, and/or the microphone(s) 236 upon detection of the contactless user input. For example, the proximity sensor(s) 232 may send a signal to the controller 166 when the proximity sensor(s) 232 detects motion from the user within its detection zone, such as hand or foot waving. Additionally, or alternatively, the temperature sensor(s) 234 may send a signal to the controller 166 when the temperature sensor(s) 234 detects a temperature differential, for example, due to the body temperature of a user within the detection zone. Additionally, or alternatively, the microphone(s) 236 may send a signal to the controller 166 when the microphone(s) 236 receives a voice command.

After receiving the signal from the sensor(s) 230 at step 310, step 320 may include controlling the operation of the linear actuator 210 and the motor 226 to move the door 134 from the closed position to the open position upon detection of the contactless user input by the sensor(s) 230. As such, in some embodiments, the controller 166 may first determine whether to open the door 134 of the washing machine appliance 100. For example, after receiving the signal from the proximity sensor(s) 232 when the proximity sensor(s) 232 detects motion from the user within its detection zone, the controller 166 may determine that the door 134 should be opened. Additionally, or alternative, after receiving the signal from the temperature sensor(s) 234, the controller 166 may determine that the door 134 of the washing machine appliance 100 should be opened when the temperature differential detected by the temperature sensor(s) 234 exceeds a predetermined temperature threshold that, for example, may be stored within a memory of the controller 166. Additionally, or alternatively, after receiving the signal from the microphone(s) 236, the controller 166 may analyze the voice command received by the microphone(s) 236 to determine whether the voice command corresponds to a command to open the door 134 and, if so, determine that the door 134 should be opened. Furthermore, in some embodiments, the controller 166 may also analyze the voice command received by the microphone(s) 236 to determine whether the voice command was received from a specific user, and if received from the specific user, determine that the door 134 should be opened. After determining that the door 134 should be opened, the controller 166 may control the operation of the linear actuator 210 to move the rod 212 from the retracted position to the extended position.

Additionally, after the controller 166 controls the operation of the linear actuator 210 to move the rod 212 from the retracted position to the extended position and, thus, moving the door 134 of the washing machine appliance 100 from the closed position, the controller 166 may control the operation of the motor 226 to move the door 134 to the open position. For example, the controller 166 may activate or turn on the motor 226 such that the motor 226 drives rotation of the shaft 224 to move the door 134 to the open position once the door 134 has been moved from the closed position by the rod 212 of the linear actuator 210.

As explained herein, aspects of the present subject matter are generally directed to an automatic door opening assembly design of a washing machine appliance that includes a linear actuator, one or more sensors, and a controller. This automatic door opening assembly allows the sensor(s) to detect a contactless user input by a user of the washing machine appliance and uses the controller to control the operation of the linear actuator to move the door from the closed position upon detection of the contactless user input by the sensor(s). This allows users to automatically open the door of the washing machine appliance without touching the washing machine appliance to do so which may be useful, for example, when a user's hands are occupied.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance comprising:
a cabinet comprising a front panel defining a chamber opening;
a wash tub positioned within the cabinet and defining a wash chamber;
a door rotatably mounted to the front panel and moveable between an open position for providing access to the wash chamber and a closed position for prohibiting access to the wash chamber; and
an automatic door opening assembly for selectively rotating the door from the closed position to the open position, the automatic door opening assembly comprising:
a linear actuator comprising a rod moveable between a retracted position and an extended position in which the rod moves the door from the closed position;
a sensor for detecting a contactless user input to move the door from the closed position to the open position; and
a controller operatively coupled to the sensor and the linear actuator, the controller configured to control an operation of the linear actuator to move the rod from the retracted position to the extended position upon detection of the contactless user input by the sensor.

2. The washing machine appliance of claim 1, the automatic door opening assembly further comprising:
a door hinge coupled to the door and the front panel for facilitating rotation of the door between the open position and the closed position; and
a hinge actuator coupled to the door hinge for moving the door to the open position after the linear actuator moves the door from the closed position.

3. The washing machine appliance of claim 2, wherein the hinge actuator is configured as a coil spring for applying a pressure between the door and the front panel of the cabinet for moving the door to the open position after the linear actuator moves the door from the closed position.

4. The washing machine appliance of claim 2, wherein the hinge actuator is configured as a motor operable to move the door to the open position after the linear actuator moves the door from the closed position.

5. The washing machine appliance of claim 4, wherein the controller is operatively coupled to the motor, the controller further configured to:
after controlling the operation of the linear actuator to move the rod from the retracted position to the extended position, control an operation of the motor to move the door to the open position.

6. The washing machine appliance of claim 1, wherein the sensor is configured as a proximity sensor for detecting the contactless user input.

7. The washing machine appliance of claim 6, wherein:
the proximity sensor is configured to detect motion corresponding to the contactless user input; and
the controller is further configured to control the operation of the linear actuator to move the rod from the retracted position to the extended position when the motion is detected by the proximity sensor.

8. The washing machine appliance of claim 6, wherein:
the proximity sensor is positioned on the front panel of the washing machine appliance below the door.

9. The washing machine appliance of claim 1, wherein:
the sensor is configured as a temperature sensor for detecting a temperature differential corresponding to the contactless user input; and
the controller is further configured to control the operation of the linear actuator to move the rod from the retracted position to the extended position when the temperature differential exceeds a predetermined temperature threshold.

10. The washing machine appliance of claim 9, wherein the temperature sensor is positioned on the front panel of the washing machine below the door.

11. The washing machine appliance of claim 1, wherein:
the sensor is configured as a microphone for receiving a voice command; and
the controller is further configured to:
determine when the voice command is a command to open the door; and
control the operation of the linear actuator to move the rod from the retracted position to the extended position when determined that the voice command is a command to open the door.

12. The washing machine appliance of claim 11, wherein the controller is further configured to:
determine when the voice command is a command to open the door from a specific user; and
control the operation of the linear actuator move the rod from the retracted position to the extended position when determined that the voice command is a command to open the door from the specific user.

13. An automatic door opening assembly for a washing machine appliance, the washing machine appliance including a cabinet including a front panel defining a chamber opening, a wash tub positioned within the cabinet and defining a wash chamber, and a door rotatably mounted to the front panel and moveable between an open position for providing access to the wash chamber and a closed position for prohibiting access to the wash chamber, the automatic door opening assembly comprising:
a linear actuator comprising a rod moveable between a retracted position and an extended position in which the rod moves the door from the closed position;
a sensor for detecting a contactless user input to move the door from the closed position to the open position; and
a controller operatively coupled to the sensor and the linear actuator, the controller configured to control an operation of the linear actuator to move the rod from the retracted position to the extended position upon detection of the contactless user input by the sensor.

14. The automatic door opening assembly of claim 13, further comprising:
a door hinge coupled to the door and the front panel for facilitating rotation of the door between the open position and the closed position; and
a hinge actuator coupled to the door hinge for moving the door to the open position after the linear actuator moves the door from the closed position.

15. The automatic door opening assembly of claim 14, wherein the hinge actuator is configured as a coil spring for applying a pressure between the door and the front panel of the cabinet for moving the door to the open position after the linear actuator moves the door from the closed position.

16. The automatic door opening assembly of claim 14, wherein the hinge actuator is configured as a motor operable to move the door to the open position after the linear actuator moves the door from the closed position.

17. The automatic door opening assembly of claim 13, wherein:
the sensor is configured as a temperature sensor for detecting a temperature differential corresponding to the contactless user input; and
the controller is further configured to control the operation of the linear actuator to move the rod from the retracted position to the extended position when the temperature differential exceeds a predetermined temperature threshold.

18. The automatic door opening assembly of claim 13, wherein:
the sensor is configured as a proximity sensor for detecting motion corresponding to the contactless user input; and
the controller is further configured to control the operation of the linear actuator to move the rod from the retracted position to the extended position when the motion is detected by the proximity sensor.

19. The automatic door opening assembly of claim 13, wherein:
the sensor is configured as a microphone for receiving a voice command; and
the controller is further configured to:
determine when the voice command is a command to open the door; and
control the operation of the linear actuator to move the rod from the retracted position to the extended position when determined that the voice command is a command to open the door.

20. The automatic door opening assembly of claim 13, further comprising:
a switch for activating by the user,
wherein, the controller is operatively coupled to the switch, the controller further configured to:
control the operation of the linear actuator to move the rod from the retracted position to the extended position when the switch is activated by the user.
